(19) United States
(12) Patent Application Publication
(10) Pub. No.: US 2003/0065954 A1
(43) Pub. Date: Apr. 3, 2003

(54) Remote desktop interface

(76) Inventors: Keegan F. O'Neill, Victoria (CA); Joseph Supple, Victoria (CA); Timothy A. Perkins, Sidney (CA)

Correspondence Address: MORLAND C FISCHER, 2030 MAIN ST, SUITE 1050, IRVINE, CA, 92614

(21) Appl. No.: 09/964,373

(22) Filed: Sep. 28, 2001

(51) Int. Cl. H04L 9/32

(52) U.S. Cl. 713/202

(57) ABSTRACT

A method for allowing an authorized user to securely change his password on a host computer from a remote workstation without logging onto the host computer, especially in cases where the authorized user has forgotten his assigned password. Provided that the authorized user can successfully answer personal questions that are presented to him from the host computer, a computer program is transferred from the host computer to the remote workstation to enable the authorized user's password to be reset. Once the program is run and the authorized user's password is reset, the program is completely deleted from the remote workstation.

### BACKGROUND OF THE INVENTION

1. Field of the Invention

In general, this invention relates to an apparatus and method for allowing a remote user, at a remote computer workstation, to run a program that is not stored on the remote computer workstation and without requiring that the user log onto a host computer. More particularly, the present invention enables a computer user to quickly and securely change his own personal password on a host computer without logging onto the host computer.

2. Background Art

Currently, an authorized user of a host computer or network who has forgotten his password, or whose password has expired, is denied access to the host system. He must request a new password from a help desk, a procedure which is expensive, subject to security breaches by hackers, and delays the users access to the system until his new password is issued and arrives. The delay, where employee access to work related computer systems is involved, results in loss of productivity.

Alternatively, a user desiring to run a computer software program at his workstation is required to store a copy of that program on his computer. This requires that the software be loaded onto the user's computer at some time prior to use and stored in the computer memory, such as a hard drive or the like. This method requires that a portion of the computer memory be occupied for long periods of time by a program, which may be used infrequently. During periods of non-use, the program can be subject to inadvertent alteration or deletion. In addition, the stored program can become obsolete or subject to multiple upgrades during periods of non-use. In large organizations, loading the program onto a large number of workstations can be time consuming and costly and consume large amounts of storage space.

Another common procedure is for a remote user to download the computer software program from a host computer to his remote workstation. This procedure requires that the remote user log onto the host computer using a unique password, previously stored on the host computer, to identify and authorize access to the host computer and the software stored thereon. In this case, the user must remember his unique password to gain access to the host. Once access has been allowed, the desired software is downloaded from the host to the remote workstation. After use, the software still remains on the remote workstation. Consequently, otherwise available storage space is inefficiently occupied.

A primary application of the instant invention is to allow a user at a remote workstation to log onto a restricted use host computer or network even if he has lost or forgotten his password or if his password has expired. The present invention allows such authorized users to gain access to restricted host computers and networks without assistance or intervention from help-desk personnel. This advantage will eliminate the costs associated with help-desk assisted password resets and the additional costs associated with the loss of employee productivity resulting from employees who are unable to access the computer resources they need to do their jobs because their passwords have been forgotten or have expired. In extranet and e-business environments, business that has heretofor been lost when partners and customers are unable to log-on because they have forgotten their passwords, is now eliminated. Because this invention ensures that proper security procedures and policies are followed in the log-on procedure, enterprise security is greatly improved. Security is further enhanced by the elimination of hacker susceptible help-desk password resets.

The software by which the aforementioned advantages are achieved can be run on a primary domain controller, whereby there is no need to install and maintain additional client software on user workstations. Therefore, installation costs and the on-going manpower, support and maintenance costs usually associated with client software running on each workstation are eliminated

### SUMMARY OF THE INVENTION

A method and apparatus are disclosed by which a user is able to reset his personal password on a host computer from a remote workstation without logging onto the host computer or remote workstation by executing a program that is not stored on the remote workstation. Initially, a user selected series of questions and the corresponding answers are stored when the host computer is first accessed. Following this initial user registration, the method comprises the additional steps of the user connecting to the host computer, attempting a log-on using a default user name, verifying the default user name, capturing the identity of the remote workstation, transferring a remote desktop interface computer program to the remote workstation, installing the remote desktop interface program on the remote workstation, running the remote desktop interface program on the remote workstation, inputting a new user password on the remote workstation, sending the new user password to the host computer, resetting the user password on the host computer, and completely removing the remote desktop interface computer program from the remote workstation.

By virtue of the foregoing, the user of a remote workstation will be able to log onto a host computer without logging into a remote workstation or the host computer and to subsequently change his password on the host system without logging in. In addition, a system and a method will be available for running a computer program on a user's remote workstation without having to store the program on the user's remote workstation and without requiring the user to log onto a host terminal to access the program.

What is more, a large number of users can have ready access to the latest updated versions of computer programs without the expense and time consuming inconvenience of having to update the programs at each individual workstation.

In addition, a user of a remote workstation will be able to run a program stored on a host computer without over-burdening the central processing unit of the host computer. The user will also have access to and the use of numerous computer programs without having to store these programs on the storage device of the remote workstation thereby freeing up memory on the remote workstation storage device. The user will also have access to and the use of a large number of computer programs which are not susceptible to inadvertent or purposeful erasure or modification. Furthermore, the user will be able to download a program from a host computer to the remote workstation, to use the program, and to then completely remove all traces of the program from the remote workstation whereby the user has complete use of the downloaded program without consuming or using any of the permanent memory of the remote workstation.

### BRIEF DESCRIPTION OF THE DRAWINGS

FIG. 1 is a pictorial representation which shows the relationship between a remote desktop interface, or workstation, and a pair of host computers according to the apparatus which forms this invention;

FIG. 1a illustrates the steps by which a new user initially registers his identity with the host computers;

FIGS. 2a and 2b show a flowchart to represent the method which forms this invention;

FIG. 3 is a block diagram to represent the steps by which to initiate a program uninstall from the method of FIGS. 2a and 2b; and

FIGS. 4a-4d represent the steps by which to initiate a log-on attempt from the method of FIGS. 2a and 2b.

### DETAILED DESCRIPTION

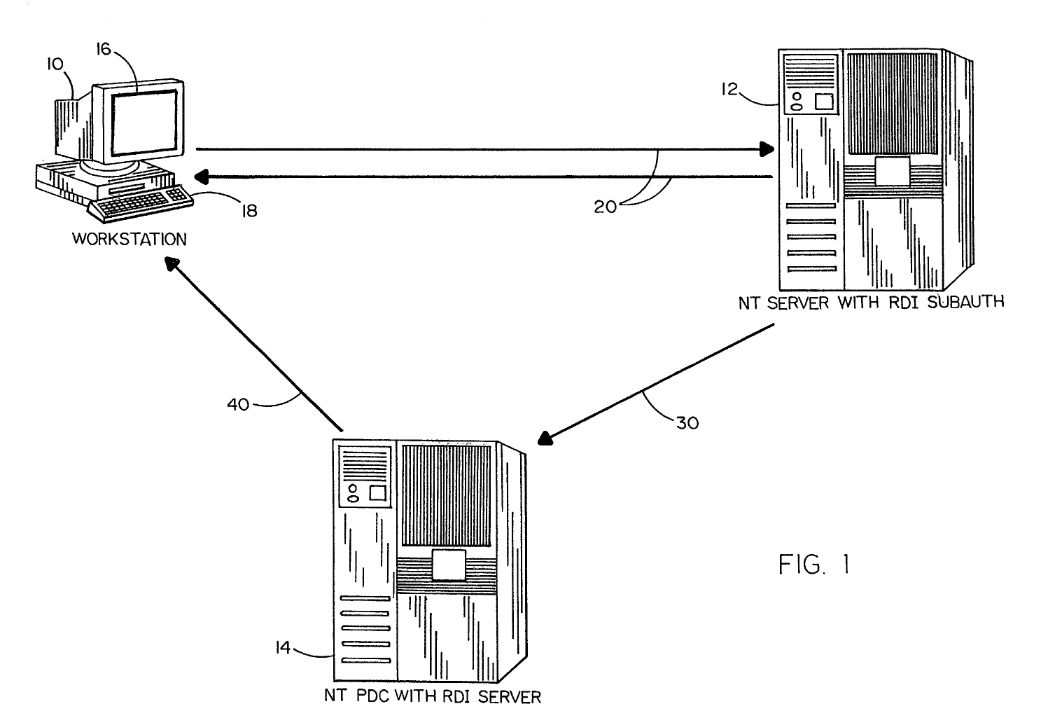

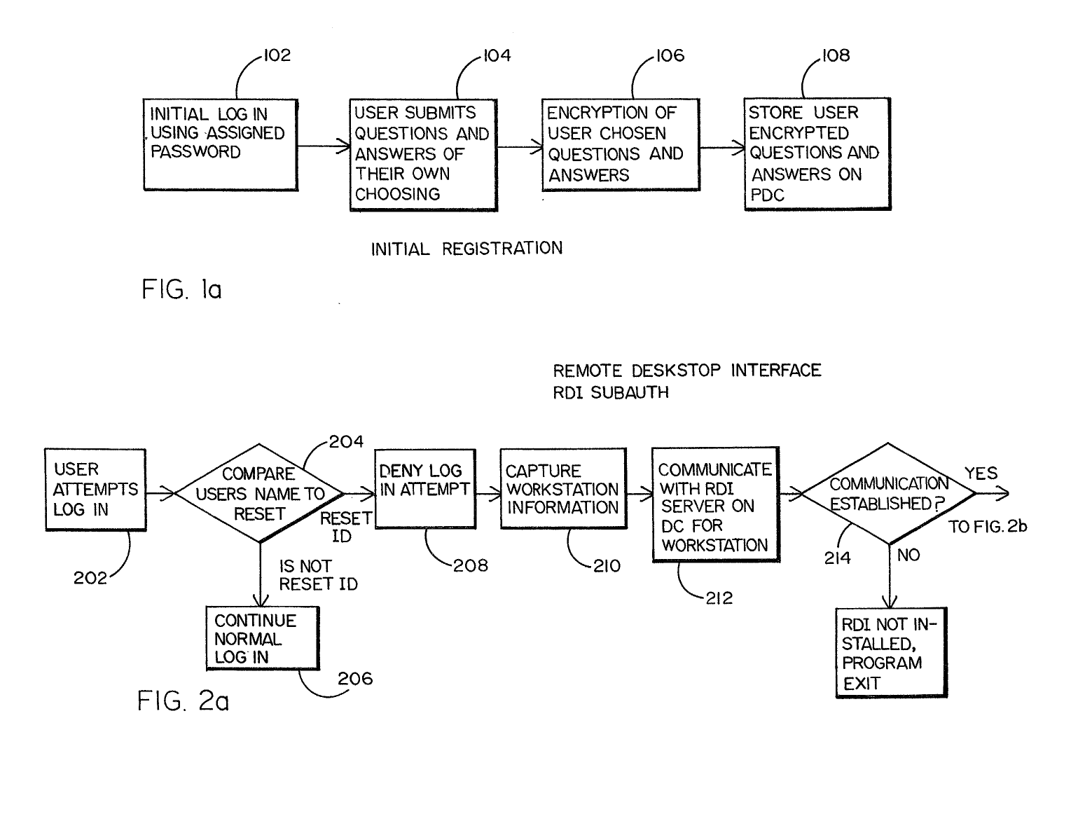

FIG. 1 illustrates the relationship between a remote terminal (RDI) or workstation 10 and a pair of host computers comprising a network authentication (e.g. NT) server 12 and a network primary domain (e.g. NT PDC) controller 14 arranged in a network according to the present invention. The workstation 10 is shown running on a domain in a local area network (LAN) typically connected through a cable or over a phone line 40 which is controlled by the domain controller 14. The workstation 10 attempts to log-on or connect to the authentication server 12 typically through a network 20. By way of example, workstation 10 is a personal computer using a WINDOWS NT operating system or the like and containing a PENTIUM class of microprocessor, a plurality of both random access memory (RAM) and read only memory (ROM), a hard drive permanent storage device of suitable capacity, a display 16 which is typically either a cathode ray tube type display or a liquid crystal type display, a keyboard 18, a power supply and a network interface card.

Authentication server 12 can be any general-purpose network server capable of running network software. In the preferred embodiment, server 12 runs MICROSOFT NT software with RDI subauth subroutines as part of a subauthentication package that supplements or replaces some of the authentication and validation criteria used by the main authentication package. Server 12 is coupled to domain controller 14 through Ethernet cable or similar computer network coupling cabling 30.

Domain controller 14 can be any general-purpose network server capable of running network software. In the preferred embodiment, domain controller 14 runs MICROSOFT NT software with RDI service which runs as a domain administrator to allow the network access to all workstations in the domain. The standard RDI service includes a commonly known RDI Popup service program. As described above, controller 14 is coupled to both remote desktop interface 10 and authentication server 12 through Ethernet cabling, telephone lines and modems, or any other suitable computer network cabling (designated 40 and 30 in FIG. 1).

The functions of authentication server 12 and domain controller 14 can be combined into a single host computer (not shown) running network software. In the preferred embodiment, the software that is run by the authentication server 12 and the domain controller 14, whether operating as two separate computers (as shown) or as a single combined computer, is MICROSOFT NT software containing RDI subauth and RDI server subroutines.

A primary application of the apparatus shown in FIG. 1 is to allow a user of the remote workstation 10 to log onto a host computer without using his password and to subsequently change his password. The method of this invention begins with a user's initial registration, as shown in FIG. 1a of the drawings, when a new authorized user who has been assigned a password logs onto the authentication server 12 (step 102) from his workstation. The user enters a series of questions and the corresponding answers of his own choosing (step 104). The series of questions and answers are encrypted (step 106) and then stored in the PDC domain controller 14 (step 108).

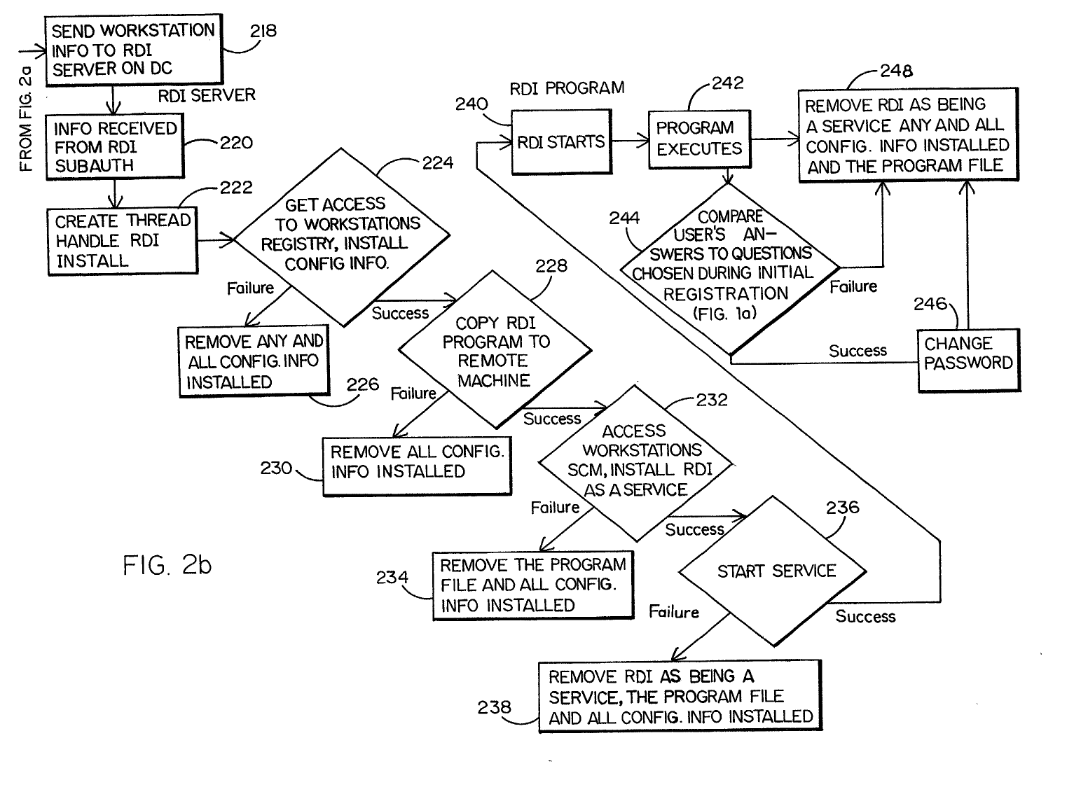

Referring now to FIGS. 2a and 2b of the drawings, there is shown a block diagram to illustrate the steps by which the user can later log onto the host computer without using his password, especially in cases where he has forgotten his password. The operation starts at step 202 when a user attempts to log onto a host computer. The log-on attempt is captured by the RDI subauth routine residing in the authentication server 12. The “user name” used for the log-on attempt is compared to a stored value know as the “Reset Account Name” (step 204). If the “user name” does not match the “Reset Account Name”, the method proceeds with the normal NT log-on procedures (step 206). Next, the data processor compares the “user name” with user names stored in a data structure in the authentication server 12 to determine whether normal log-on access will be allowed or denied. The remote desktop interface program reverts to a wait status to wait for the next log-on attempt.

If the “user name” matches the “Reset Account Name”, the RDI installation process is initiated. The authentication server 12 captures the identity of the remote workstation 10 by its name and address (step 210). The “Reset” account is denied access to the host computer, and an access denied indication is returned to the user who initiated the reset (step 208).

The authentication server 12 then establishes communication with the domain controller 14 of the workstation's domain (step 212). An attempt is made to establish communication through a remote procedure call (RPC) connection between the subauth routine in authentication server 12 and the RDI server in domain controller 14 using TCP/IP protocol (step 214). If RDI is not installed on domain controller 14, the attempt to establish communication is reported as an error and the RDI installation process is terminated (step 216).

If connection between authentication server 12 and domain controller 14 is established, the workstation identity information is sent to the RDI server or, in this case, the domain controller 14 (step 218). The RDI server (i.e. domain controller 14) running as a service, receives the workstation identification information from the RDI subauth (step 220). A thread is started in authentication server 12 to initiate the processing and the main thread returns to wait status (step 222). The thread uses the identification information from the remote desktop interface 10 to attempt to connect to and open a remote pipe to the registry on remote desktop interface 10 (step 224). Configuration information is installed through the remote pipe, and keys and values necessary to the RDI Popup are created. If the installation of the configuration information on the workstation registry is not completely successful, all configuration information that was installed on the workstation 10 is removed and the RDI installation process is terminated (step 226).

If the configuration information is installed correctly in the registry of the remote workstation 10, an attempt is made to open a pipe to the Admin$ share of the workstation 10 and write the RDI Popup program (step 228). If the write of the RDI Popup is not completed successfully, all configuration information that was installed in the previous step is removed, the pipe is closed and the install process is terminated (step 230).

If the write of the RDI Popup is successful, an attempt is made to open a handle to the remote service control manager (SCM) and the RDI Popup program is installed as a service on the remote workstation 10 (step 232). If the RDI Popup is not successfully installed as a service on the remote workstation 10, the program file and all configurations are completely removed (unistalled) and the RDI installation process is terminated (step 234).

If the RDI program is successfully installed as a service, an attempt is made to start the service (step 236). If the service fails to start, the program is removed (uninstalled) from the workstation as a service and the program file and all configuration information that had been installed are removed (step 238). If the service starts on the remote desktop interface 10, the thread is terminated (step 240). The program executes and an interface pops up on the “secure desktop.” The user then executes the program (step 242). The user then establishes his identity by correctly answering the questions (step 244) that were previously chosen and stored during the initial user registration of FIG. 1a. If the user does not correctly answer the questions, the RDI program terminates and the program file and any configuration information are removed (step 248). However, if the earlier chosen questions are answered correctly, the user may now input his chosen new password at the remote desktop interface 10. The new password is copied to the authentication server 12 and is entered as a changed password (step 246). After all tasks are finished, the RDI program first removes itself along with all of the installed RDI data from the remote workstation 10 and then quits operating (step 248).

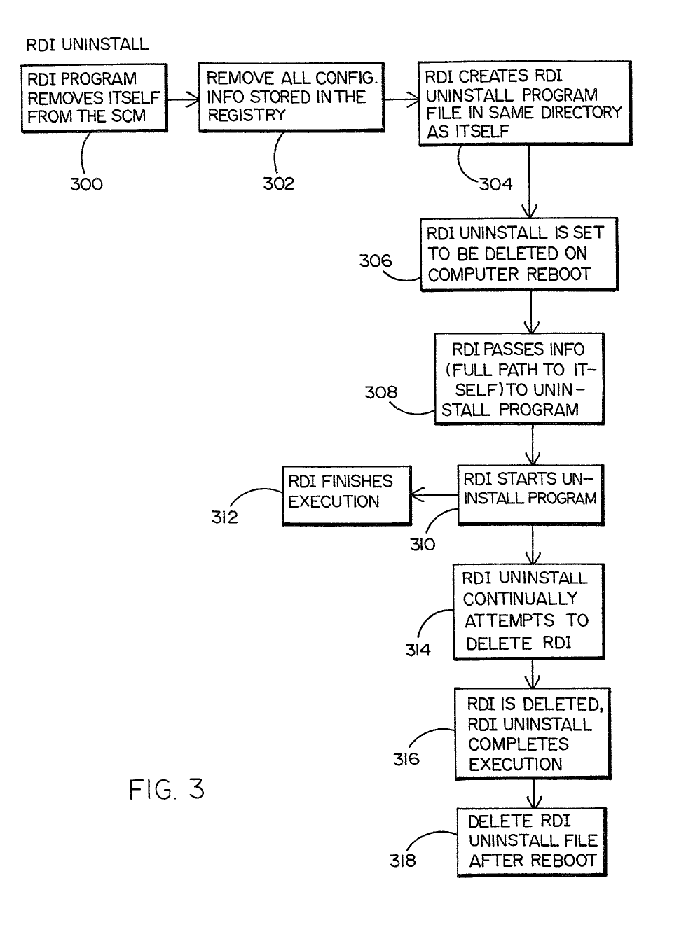

The removal (uninstall) procedure is described when referring to FIG. 3. The RDI program removes all configuration information stored in the workstation registry (step 302). The RDI program creates an RDI uninstall program file in the same directory in which it resides (step 304). The RDI uninstall program file is set to be deleted when the workstation is rebooted (step 306). In step 308, the RDI program passes RDI delete instructions to the RDI uninstall program file (fill path to itself). The RDI program starts the RDI uninstall program, which is in the RDI uninstall program file (step 310). The RDI program finishes execution and stops running (step 312). The RDI uninstall program runs and continually attempts to delete the RDI program (step 314). When the RDI program has been deleted, The RDI uninstall program completes execution and stops running (step 316). The next time the workstation is booted, the RDI uninstall program file and its contents are deleted (step 318).

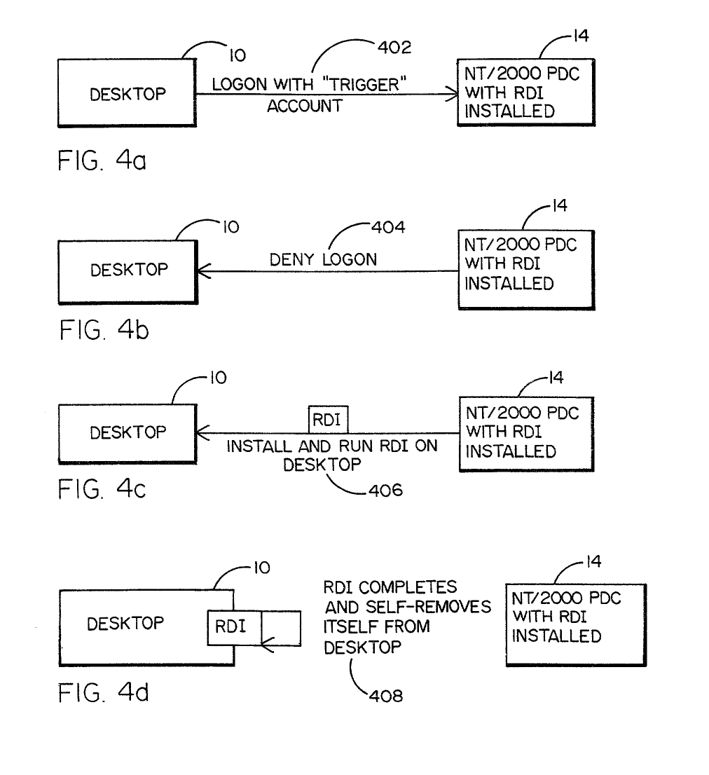

The aforementioned operation illustrated in FIGS. 2a and 2b is diagrammatically summarized by the block diagram shown in FIGS. 4a-4d of the drawings. First, in FIG. 4a, the user attempts to log-on from a remote desktop interface 10 to an authentication server 12 (e.g., a NT/2000 server with RDI subauth installed) using a trigger account name or reset account name (step 402). In FIG. 4b, if the trigger or reset account name is authentic, the authentication server 12 sends an “access denied” message to the remote desktop interface 10 denying the log-on attempt (step 404). In FIG. 4c, the domain controller 14 (e.g., a NT/2000 PDC with RDI server software installed) installs the RDI software on the remote desktop interface 10 on which it runs (step 406). Finally, in FIG. 4d, after the RDI software completes running, it deletes itself from the remote desktop interface 10 (step 408).

Another application of this invention is a method to enable a software program to run on a remote workstation wherein the program is not actually installed on the remote workstation. FIG. 1 illustrates the interconnection between a remote desktop interface (i.e. workstation) 10, authentication server 12, and domain controller 14 as explained above.

Referring once again to FIGS. 2a and 2b, the method of logging onto a host computer from the remote workstation 10 is now described in the complete context of changing a user's password. By using a truncated version of this method, a more general procedure will be available for running a program on remote workstation 10 when the program has not actually been installed on the remote workstation 10.

The procedure begins with the user at a remote workstation 10 establishing communication with the authentication server 12 that functions as the host of the program that he desires to use. After communication is established, the user attempts a log-on either through a normal log-on procedure or the procedure of resetting the user password in the manner described above while referring to FIGS. 2a and 2b. After logging on, the user selects the program that he desires to use and it is downloaded to his workstation. The user then runs the downloaded program at his workstation. After his use of the program has been completed, the program is completely removed from his workstation using the uninstall feature shown in FIG. 3.

Accordingly, it can be seen that the above described invention provides a system and method of running a computer program on a user's remote workstation wherein the program has not been stored on that remote workstation and the user has not had to log onto a host terminal to access the program. It may also be appreciated that the method herein described allows the user of a remote workstation to log onto a host computer without using his password and to subsequently change his password. Additionally, this invention provides a system and method of allowing the user of a remote workstation to download a program from a host computer to a remote workstation, use the program and, when finished, completely remove all traces of the program from the remote workstation, whereby the user is able to have the complete use of the most current version of a computer program without depleting or using any of the permanent storage space that is available at the remote terminal.

This invention also provides the advantage of allowing a plurality of users access to the latest versions of computer programs without the expense and time-consuming inconvenience of having to update programs at each individual workstation. Another benefit of the disclosed method and apparatus is to allow a plurality of users the ability to run a program stored on a host computer without over burdening the central processing unit of the host computer. This feature further allows a user to access and use a large number of computer programs, which are not susceptible to inadvertent or purposeful erasure or modification.

We claim:

1. A method for enabling an original password to be reset on a host computer from a remote workstation by an authorized user without logging onto the host computer, said method comprising the steps of:
storing on said host computer a user registration profile including personal information selected by the authorized user;
connecting said remote workstation to said host computer and capturing the identity of said remote workstation by said host computer;
interrogating the authorized user for the personal information stored on said host computer as said user registration profile;
comparing the personal information provided by the authorized user with the personal information stored on said host computer;
sending a new user password from said remote workstation to said host computer, provided that the personal information provided by the authorized user matches the personal information that is stored on said host computer; and
resetting the original password on the host computer with said new user password.

2. The method recited in claim 1, including the additional step of the authorized user picking questions and the corresponding answers to be stored on the host computer as the personal information that forms said user registration profile.

3. The method recited in claim 1, including the additional steps of encrypting said user registration profile; and storing said encrypted user registration profile at a secure location of said host computer.

4. The method recited in claim 1, including the additional steps of storing on said host computer a computer program that is adapted to cause the original password to be reset with the new password sent from said remote workstation to said host computer; transferring said computer program from said host computer to said remote workstation; and executing the computer program on said remote workstation provided that the personal information provided by the authorized user matches the personal information that is stored on said host computer as said user registration profile.

5. The method recited in claim 4, including the additional step of deleting said computer program from said remote workstation following the step of resetting the original user password on the host computer with the new password.

6. The method recited in claim 1, including the additional steps of the authorized user attempting to log onto the host computer from the remote workstation by using a known user name; comparing said known user name with a predetermined reset account name stored on the host computer; and allowing the remote workstation to access the host computer prior to the step of the host computer capturing the identity of the remote workstation, provided that the known user name of the authorized user matches the reset account name stored on the host computer.
